(19) United States
(12) Patent Application Publication
(10) Pub. No.: US 2012/0043025 A1
(43) Pub. Date: Feb. 23, 2012

(54) TAPE AND LABEL APPLICATOR

(76) Inventor: Hsiu-Man YU CHEN, Tan Tzu Township (TW)

(21) Appl. No.: 12/859,131

(22) Filed: Aug. 18, 2010

(51) Int. Cl. B32B 38/04

(52) U.S. Cl. 156/512

(57) ABSTRACT

A tap and label applicator includes a base. The base is provided with an operation rod, a tape cutting unit and a label stripping unit. At least one roll of tape and one roll of labels are mounted on the tape and label applicator. The tape cutting unit is used to cut the tape of the roll of tape. The label stripping unit can automatically peel off the labels on the roll of labels. The present invention can save the space and avoid loss of the roll of tape and the roll of labels to facilitate the process of packing.

### BACKGROUND OF THE INVENTION

1. Field of the Invention

The present invention relates to a tape and label applicator.

2. Description of the Prior Art

Cartons are widely used to load articles, which not only transports conveniently but also protects articles. In general, the user uses a tape to seal the cartons, preventing the articles from dropping and damage during transportation. The cartons are always stuck with various labels for warning. In order to accelerate the process, the user usually uses a tape applicator and a label stripping device to assist the tasks of sealing cartons and sticking labels. However, the tape applicator and the label stripping device are two separate devices. Not all the cartons need labels. Sometimes, the user may lose the tape applicator or the label stripping device during work. Accordingly, the inventor of the present invention has devoted himself based on his many years of practical experiences to solve this problem and develop a tape and label applicator having multiple functions.

### SUMMARY OF THE INVENTION

The present invention is to provide a tap and label applicator which comprises a base, an operation rod, a tape cutting unit, and a label stripping unit. The base has two parallel standing plates. The operation rod is disposed between the two standing plates. The tape cutting unit is disposed between the two standing plates. The tape cutting unit comprises a fixed plate, a blade, a protection plate and an elastic member. Two end of the fixed plate is fixed to the two standing plates, respectively. The blade is fixed on one side of the fixed plate. Two ends of the protection plates are pivotally connected to the two standing plates respectively and connected with the elastic member. The protection plate is against one side of the blade opposite to the fixed plate. The label stripping unit is disposed between the two standing plates. The label stripping unit comprises a guide rod, a guide plate and a separating rod. The guide rod is located above the guide plate. A gap is defined between the guide rod and the guide plate. The separating rod is located under the guide plate. A space is defined between the separating rod and the guide plate. At least one roll of tape and one roll of labels are mounted on the tape and label applicator. The tape cutting unit is used to cut the tape of the roll of tape. The label stripping unit can automatically peel off the labels on the roll of labels. The present invention can save the space and avoid loss of the roll of tape and the roll of labels to facilitate the process of packing.

### BRIEF DESCRIPTION OF THE DRAWINGS

FIG. 1 is a perspective view according to a preferred embodiment of the present invention;

FIG. 2 is an exploded view according to the preferred embodiment of the present invention;

FIG. 3 is a cross-sectional view according to the preferred embodiment of the present invention;

FIG. 4 is a schematic view of the preferred embodiment when in use;

FIG. 5 is a partially enlarged view of the tape cutting unit according to the preferred embodiment of the present invention;

FIG. 6 is a schematic view showing the operation of the preferred embodiment of the present invention; and

FIG. 7 is a partially enlarged view of the label stripping unit according to the preferred embodiment of the present invention.

### DETAILED DESCRIPTION OF THE PREFERRED EMBODIMENTS

Embodiments of the present invention will now be described, by way of example only, with reference to the accompanying drawings.

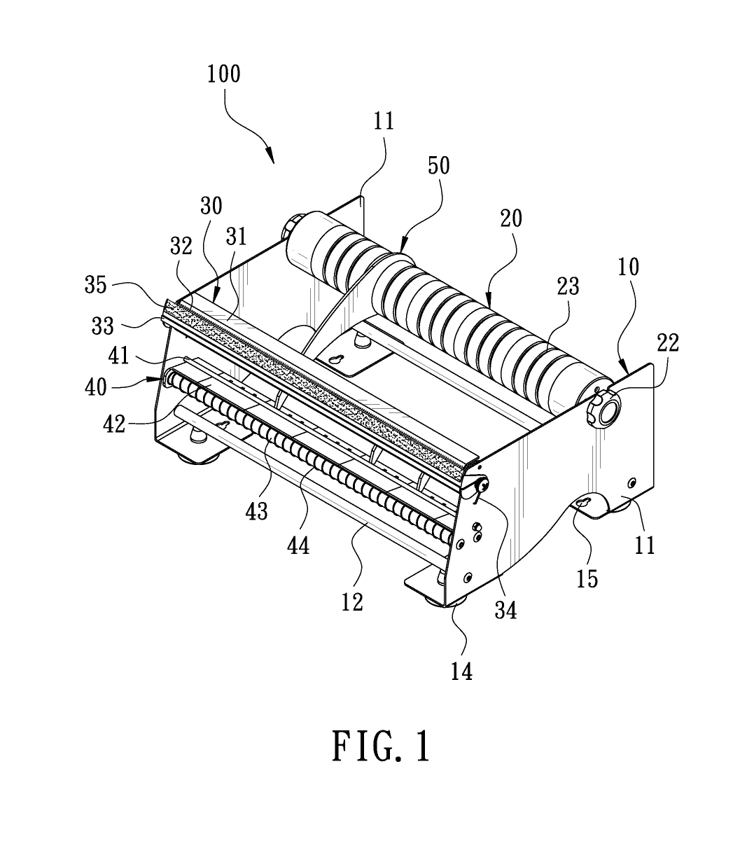

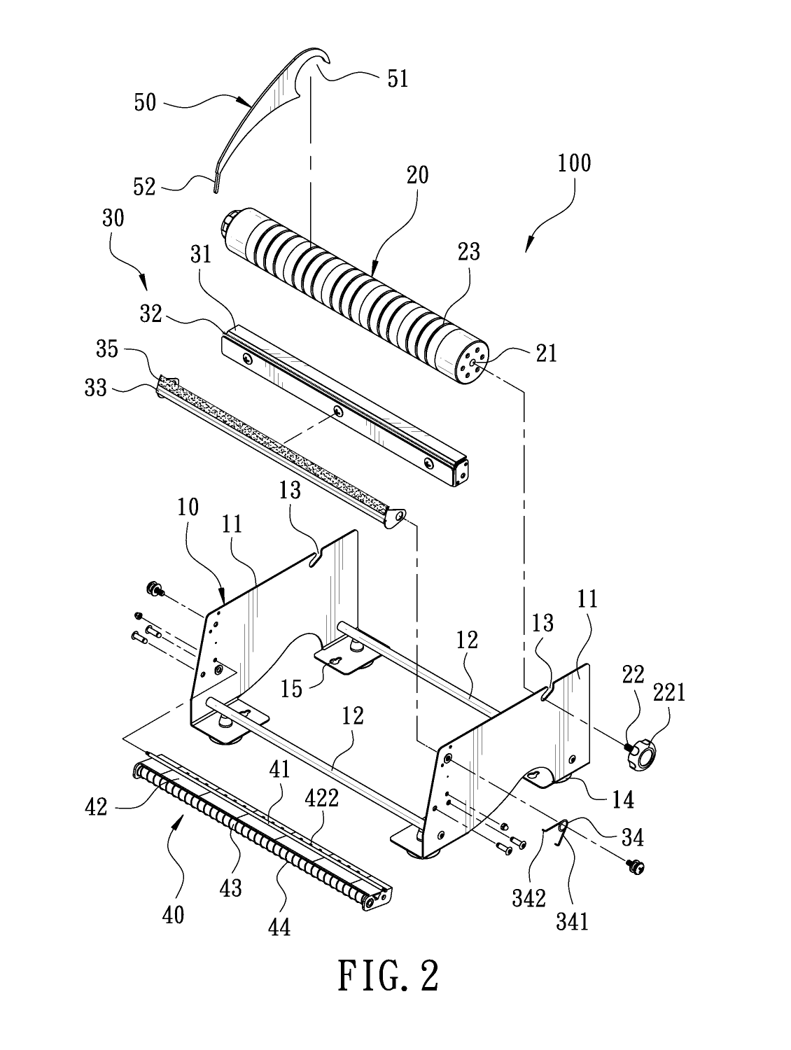

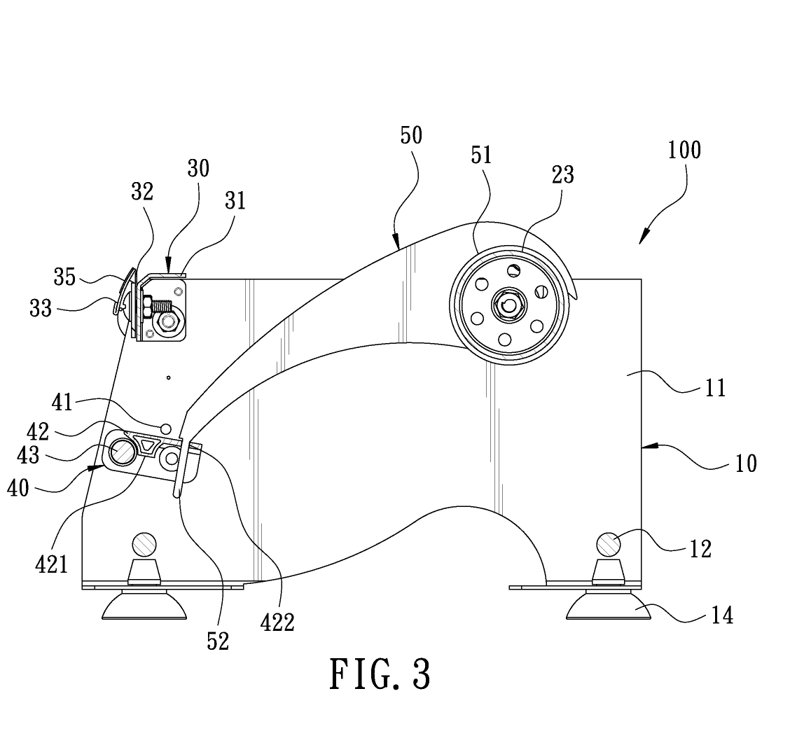

As shown in FIG. 1 to FIG. 3, a tap and label applicator 100 according to a preferred embodiment of the present invention comprises a base 10, an operation rod 20, a tape cutting unit 30, a label stripping unit 40, and a plurality of separating plates 50.

The base 10 comprises two parallel standing plates 11 and a plurality of support rods 12 between the two standing plates 11. Each of the standing plates 11 has a notch 13 at a top edge thereof. The notches 13 of the two standing plates 11 correspond in position to each other. The base 10 has a bottom provided with a plurality of suckers 14 and formed with a plurality of hanging holes 15.

The operation rod 20 is disposed between the two standing plates 11. In this embodiment, the operation rod 20 has two ends each formed with a threaded hole 21 corresponding to the notch 13 for insertion of a fastening member 22. The fastening member 22 has an enlarged head 221. The operation rod 20 is engaged between the two standing plates 22 by the fastening member 22. Furthermore, the operation rod 20 has a plurality of annular grooves 23 around an outer surface thereof.

The tape cutting unit 30 is disposed between the two standing plates 11. The tape cutting unit 30 comprises a fixed plate 31, a blade 32, a protection plate 33, an elastic member 34, and a first anti-sticking member 35. Two ends of the fixed plate 31 are fixed to the two standing plates 11, respectively. The blade 32 is disposed on one side of the fixed plate 31 opposite to the operation rod 20. Two end of the protection plates 33 are pivotally connected to the two standing plates 11, respectively, and connected with the elastic member 34. In this embodiment, the elastic member 34 is a torque spring located at one end of the protection plate 33. Two ends of the elastic member 34 are defined as a fixed end 341 and an elastic end 342. The fixed end 341 is fixed to the standing plate 11. The elastic end 342 is fixed to the protection plate 33 for providing an elastic force to the protection plate 33, such that the protection plate 33 is against one side of the blade 32 opposite to the fixed plate 31. The first anti-sticking member 35 is disposed on one side of the protection plate 33 opposite to the blade 32. In this embodiment, the first anti-sticking member 35 is Velcro.

The label stripping unit 40 is disposed between the two standing plates 11 and located under the tape cutting unit 30. The label stripping unit 40 comprises a guide rod 41, a guide plate 42, a separating rod 43, and a second anti-sticking member 44. The guide rod 41 is located above the guide plate 42. A gap is defined between the guide rod 41 and the guide plate 42. The separating rod 43 is located under the guide plate 42. A space is defined between the separating rod 43 and the guide plate 42. In this embodiment, the guide plate 42 faces one side of the separating rod 43. The guide plate 42 has a guide protrusion 421 corresponding to an outer surface of the separating surface 43. A space is defined between the guide protrusion 421 and the separating rod 43. The second anti-sticking member 44 is disposed on the separating rod 43. In this embodiment, the second anti-sticking member 44 is a spiral member fitted on the separating rod 43. The guide plate 42 has a plurality of insertion holes 422 thereon.

The separating plates 50 are disposed between the operation rod 20 and the label stripping unit 40 and parallel to the two standing plates 11. In this embodiment, each of the separating plates 50 has an engaging recess 51 at one end thereof close to the operating rod 20 and an insertion post 52 at an opposing end thereof. The engaging recess 51 is engaged with the annular groove 23 and the insertion post 52 is inserted in the insertion hole 422, such that the separating plate 50 is located between the operation rod 20 and the label stripping unit 40.

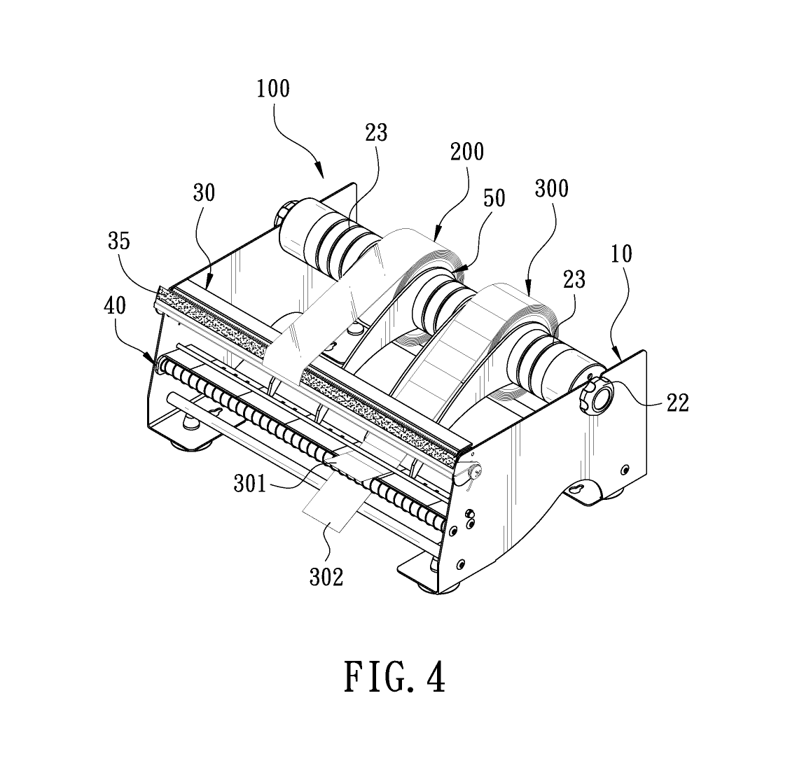

FIG. 4 is a schematic view of the preferred embodiment when in use. The tape and label applicator 100 is provided with the tape cutting unit 30 and the label stripping unit 40. A roll of tape 200 and a roll of labels 300 are mounted on the tape and label applicator 200 which is positioned at a predetermined position by means of the suckers 14 on the base 10 or hanged on a wall by means of the hanging holes 15. The user can choose to use the tape 201 of the roll of tape 200 and/or the labels 301 of the roll of labels 300. The roll of tape 200 and the roll of labels 300 are mounted on the same base 10, which can save the space and avoid loss of the roll of tape and the roll of labels to facilitate the process of packing.

When the user wants to mount the roll of tape 200 and the roll of labels 300 on the tape and label applicator 100, he/she has to take out the separating plates 50 from the base 10, and loosen the fastening members 22 at the two ends of the operating rod 20, and then disengage the operation rod 20 from the guide recesses 13 of the two standing plates 11. After that, the roll of tape 200 and the roll of labels 300 are fitted on the operation rod 20, the two ends of the operation rod 20 are engaged with the guide recesses 13 again, the fastening members 22 are screwed to secure the operation rod 22 between the two standing plates 11. The separating plates 50 are adjusted according to the width of the roll of tape 200 and the width of the roll of labels 300 to prevent the roll of tape 200 and the width of the roll of labels 300 from displacement. The tape 201 of the roll of tape 200 is pulled out to be stuck on the first anti-sticking member 35. The labels 301 of the roll of labels 300 are pulled to pass through gap between the guide rod 41 and the guide plate 42 and the release paper 302 on the back of the labels 301 is to pass through the space between the guide plate 42 and the separating rod 43. The labels 301 are stuck on the second anti-sticking member 44, such that the roll of tape 200 and the roll of labels 300 are mounted on the tape and label applicator 100. It is noted that the first anti-sticking member 35 is Velcro to effectively reduce the contact between the tape 201 and the first anti-sticking member 35, so the tape 201 can be temporarily stuck and keep its stickiness. In the same principle, the second anti-sticking member 44 is a spiral member to effectively reduce the contact between the labels 301 and the second anti-sticking member 44, so the labels 301 can be temporarily stuck and keep its stickiness.

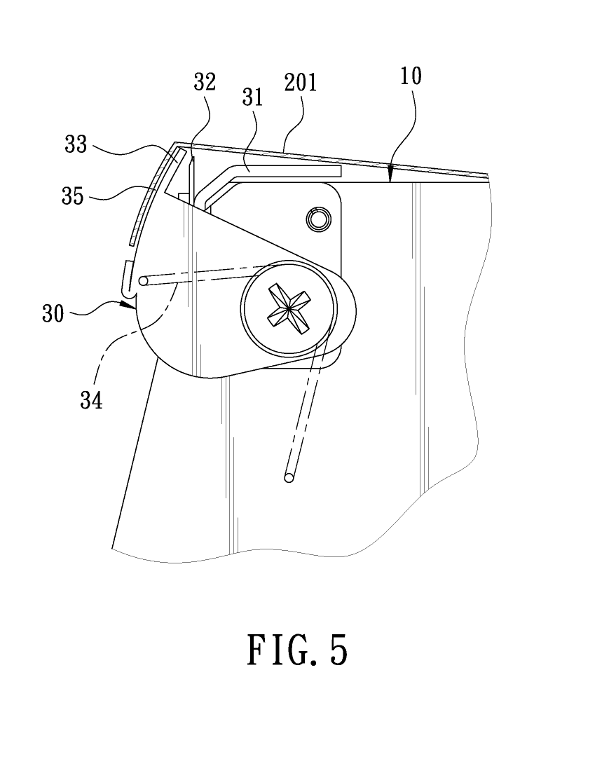

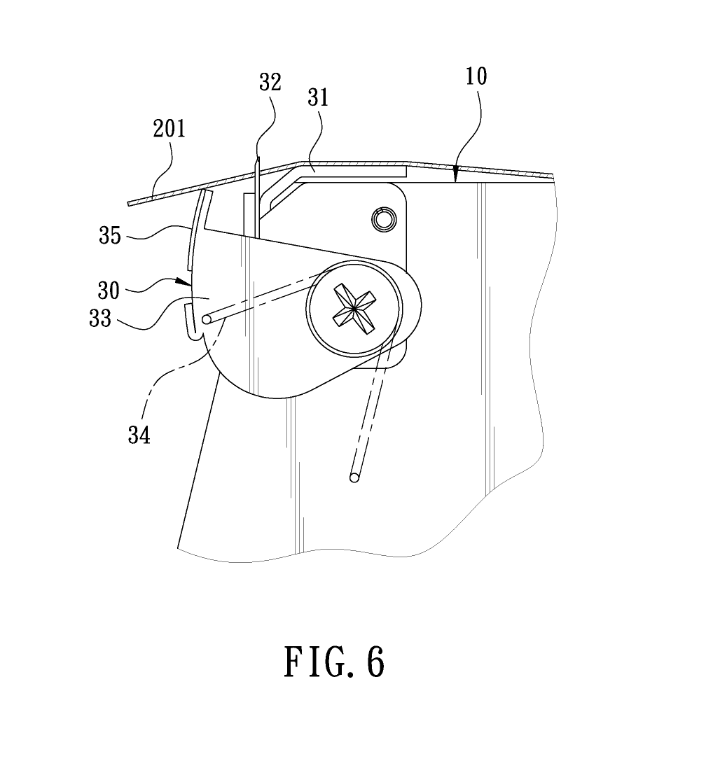

After the roll of tape 200 and the roll of labels 300 are mounted on the tape and label applicator 100, they can be used. FIG. 5 is a partially enlarged view of the tape cutting unit according to the preferred embodiment of the present invention. FIG. 6 is a schematic view showing the operation of the preferred embodiment of the present invention. When the user wants to use the tape 201, the tape 210 can be taken out from the first anti-sticking member 35 and pulled forward for a desired length and then pulled toward the blade 32. As shown in FIG. 6, the protection plate 33 will be rotated along with the tape 201 to expose the blade 32 for cutting the tape 201. It is noted that when the protection plate 33 is rotated, the protection plate 33 will compress the elastic end 342 of the elastic member 34 to store an existed force which provides the elastic force to return the protection plate 33 after the tape 201 is cut by the blade 32, preventing the user from being hurt by the blade 32.

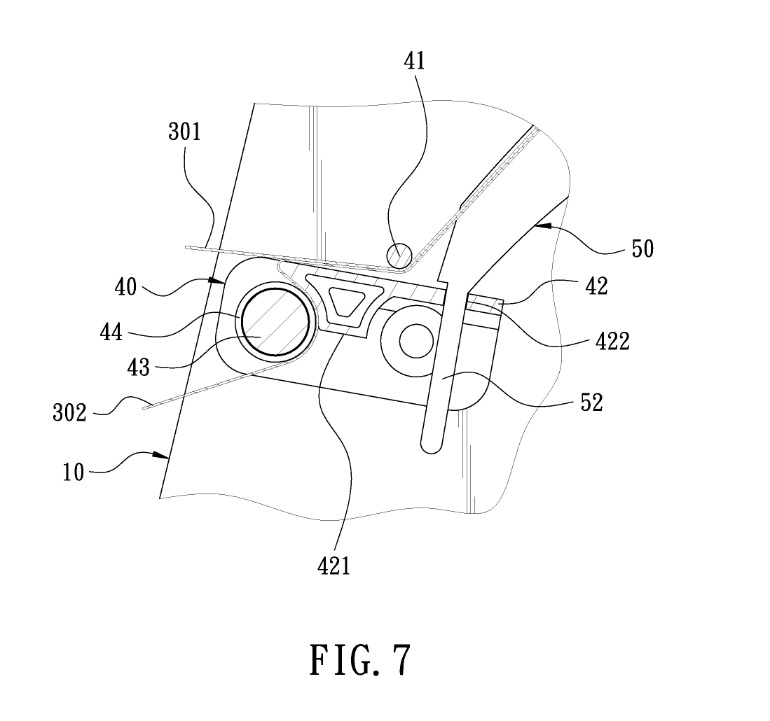

FIG. 7 is a partially enlarged view of the label stripping unit according to the preferred embodiment of the present invention. When the user wants to use the labels 301, he/she only pulls the release paper 302. The release paper 302 passes through the space to from a turning. Accordingly, when the user pulls the release paper 302, the labels 301 on the release paper 301 will oblique upward to be peeled off and stuck on the second anti-sticking member 44, such that the user can take out the labels 301 with ease.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A tap and label applicator, comprising:
a base, the base having two parallel standing plates;
an operation rod disposed between the two standing plates for mounting at least one roll of tape and one roll of labels;
a tape cutting unit disposed between the two standing plates, the tape cutting unit comprising a fixed plate, a blade, a protection plate and an elastic member, two end of the fixed plate being fixed to the two standing plates, respectively, the blade being fixed on one side of the fixed plate, two ends of the protection plates being pivotally connected to the two standing plates respectively and connected with the elastic member, the protection plate being against one side of the blade opposite to the fixed plate; and
a label stripping unit disposed between the two standing plates, the label stripping unit comprising a guide rod, a guide plate and a separating rod, the guide rod being located above the guide plate, a gap being defined between the guide rod and the guide plate, the separating rod being located under the guide plate, a space being defined between the separating rod and the guide plate.

2. The tape and label applicator as claimed in claim 1, wherein a first anti-sticking member is provided on one side of the protection plate opposite to the blade.

3. The tape and label applicator as claimed in claim 2, wherein the first anti-sticking member is Velcro.

4. The tape and label applicator as claimed in claim 1, wherein a second anti-sticking member is provided on the separating rod.

5. The tape and label applicator as claimed in claim 4, wherein the second anti-sticking member is a spiral member fitted on the separating rod.

6. The tape and label applicator as claimed in claim 1, wherein each of the standing plates has a notch at a top edge thereof, the notches of the two standing plates corresponding in position to each other, the operation rod having two ends each formed with a threaded hole corresponding to the notch for insertion of a fastening member, the fastening member having an enlarged head.

7. The tape and label applicator as claimed in claim 1, further comprising at least one separating plate, the separating plate being disposed between the operation rod and the label stripping unit and parallel to the two standing plates.

8. The tape and label applicator as claimed in claim 7, wherein the operation rod has a plurality of annular grooves around an outer surface thereof, the guide plate of the label stripping unit having a plurality of insertion holes thereon, the separating plate having an engaging recess at one end thereof close to the operating rod and an insertion post at an opposing end thereof, the engaging recess being engaged with one of the annular grooves, the insertion post being inserted in one of the insertion holes.

9. The tape and label applicator as claimed in claim 1, wherein the elastic member is a torque spring located at one of the two ends of the protection plate, two ends of the elastic member respectively defining a fixed end and an elastic end, the fixed end being fixed to the standing plate, the elastic end being is fixed to the protection plate.

10. The tape and label applicator as claimed in claim 1, wherein the base has a bottom provided with a plurality of suckers and formed with a plurality of hanging holes.
